(19) United States
(12) Patent Application Publication
(10) Pub. No.: US 2012/0100515 A1
(43) Pub. Date: Apr. 26, 2012

(54) Fluoroscopy Simulator

(75) Inventors: Eric S. Hungness, Wilmette, IL (US); Taylor J. Reif, Chicago, IL (US); Richard A. Rink, Chicago, IL (US); Byron F. Santos, Chicago, IL (US); Nathaniel J. Soper, Chicago, IL (US)

(73) Assignee: Northwestern University, Evanston, IL (US)

(21) Appl. No.: 13/276,730

(22) Filed: Oct. 19, 2011

Related U.S. Application Data
(60) Provisional application No. 61/394,956, filed on Oct. 20, 2010.

(51) Int. Cl. G09B 23/28

(52) U.S. Cl. 434/262

(57) ABSTRACT

An apparatus and machine for more realistically simulating fluoroscopy is disclosed. The apparatus includes a light source, cameras, an artificial lumen, and an access port. The artificial lumen can be comprised of an anterior side and a posterior side. The anterior side of the artificial lumen is opaque to the light source such that light reflects off the anterior side of the artificial lumen to a camera to provide a real-time extra-luminal view of an artificial lumen. The posterior side of the artificial lumen is transparent to the light source such that light passes through it, reflects off the opaque anterior side of the artificial lumen, back through the transparent posterior side of the artificial lumen to a camera to provide a real-time intra-luminal view of an artificial lumen. The cameras can be in electronic communication with video monitors to display the real-time extra-luminal and intra-luminal views.

### CROSS-REFERENCE TO RELATED APPLICATIONS

This invention claims priority from U.S. provisional patent application Ser. No. 61/394,956, filed on Oct. 20, 2010, the entire disclosure of which is incorporated herein by reference.

### BACKGROUND

Conventional fluoroscopy uses real-time x-ray imaging to observe and guide the insertion, maneuvering, and manipulation of externally controlled medical instruments inside the body. Unfortunately, due to machinery cost and exposure to x-rays, fluoroscopic medical procedures have historically been limited to clinical settings. Yet, the need exists to use fluoroscopic medical procedures in non-clinical settings such as training medical personnel new to fluoroscopy, or in the testing and demonstration of medical instruments used during fluoroscopy.

To fill this training and demonstration need, a fluoroscopy simulator must fulfill many demands. First, its must cost less to purchase than a conventional fluoroscopy machine. Since x-ray machines are expensive and expose all users to radiation, it would be ideal for the simulator to use a non-x-ray light source when simulating fluoroscopic procedures. Next, to enable students to train themselves with the simulator, it must have ports that allow access to an artificial lumen with trocars and laparoscopic tools commonly used by physicians during fluoroscopic medical procedures. Additionally, the simulator must provide all the views that a typical fluoroscopy machine would provide: the simulator must provide a real-time extra-luminal view of an artificial lumen that is used to simulate an actual lumen (e.g. intestinal tract, vessels, and ducts) that might be accessed during an actual fluoroscopic medical procedure; and the simulator must also provide a real-time intra-luminal view of an artificial lumen that is used to simulate an actual lumen (e.g. intestinal tract, vessels, and ducts) that might be accessed during an actual fluoroscopic medical procedure. Disclosed herein is a fluoroscopic simulator that fulfills these demands.

### SUMMARY

In one aspect of the invention, a non-virtual reality fluoroscopic medical procedure simulation apparatus comprising an anterior end, a posterior end, a light source, artificial lumen, cameras, and an access port is disclosed. The light source can be disposed posterior to the anterior end and oriented such that the light it emits is faced towards the artificial lumen. Further, the light source can emit light in the visible wavelength range.

The artificial lumen can have an anterior side opaque to the light source and a posterior side transparent to the light source. Alternatively, the artificial lumen can have an anterior side opaque to the light source and posterior side translucent to the light source. In another alternative, the artificial lumen can have an anterior side translucent to the light source and a posterior side transparent to the light source. In a last alternative, the artificial lumen can have an anterior side translucent to the light source and a posterior side translucent to the light source. The artificial lumen can be oriented such that the anterior side faces towards the anterior end of the apparatus, and the posterior side faces towards the posterior end of the apparatus.

The apparatus can further comprise a first camera wherein the first camera is positioned anterior to the artificial lumen and is adapted to create a digital representation of the light it receives from the light source. The apparatus can further comprise a second camera wherein the second camera is positioned posterior to the artificial lumen and is adapted to create a digital representation of the light it receives from the light source.

The apparatus may also comprise an access port. The access port can be positioned anterior to the artificial lumen and may be adapted to allow access to the artificial lumen with a medical instrument used during a fluoroscopic medical procedure.

In another aspect of the invention, the lens of the second camera may be oriented towards the posterior side of the artificial lumen and the second camera may contain a built-in algorithm to invert the left-to-right orientation of a digital representation the second camera creates of the light it receives from the light source.

In another aspect of the invention, the lens of the second camera can be oriented towards the posterior side of the artificial lumen, and the apparatus can further comprise a processor post-second camera in electronic communication with the second camera. The processor can contain a built-in algorithm to invert the left-to-right orientation of a digital representation of the light the second camera receives from the light source and that the second camera transmits to the processor.

In another aspect of the invention, the lens of the second camera is oriented towards the posterior end of the apparatus. The apparatus can also comprise a mirror having a non-reflective surface and a reflective surface. The mirror may be oriented such that its reflective surface is faced towards both the lens of the second camera and the posterior side of the artificial lumen.

In another aspect of the invention, the apparatus can comprise a video monitor in electronic communication with the first camera. Additionally, the apparatus may comprise a video monitor in electronic communication with the second camera.

In another aspect of the invention, a first non-virtual reality fluoroscopic medical procedure simulation machine comprising a light source, a first camera, a second camera, an artificial lumen and an access port is disclosed. The light source can emit light in the visible wavelength range. Both cameras can be adapted to create a digital representation of the light they receive from the light source.

The artificial lumen can have an anterior side and a posterior side. The artificial lumen can have an anterior side translucent to the light source and a posterior side can be transparent to the light source. Alternatively, the artificial lumen can have an anterior side translucent to the light source and a posterior side translucent to the light source.

The artificial lumen in the first machine can be oriented such that the anterior side is faced towards the light source. The artificial lumen can be positioned relative to the light source, first camera, and second camera such that light emitted by the light source reflects from the anterior side of the artificial lumen to the first camera, and light emitted by the light source also transmits through the anterior side and posterior sides of the artificial lumen to the second camera.

The machine can also comprise an access port. The access port can be positioned anterior to the artificial lumen and can be adapted to allow access to the artificial lumen with a medical instrument used during a fluoroscopic medical procedure.

In another aspect of the invention, the first machine can comprise a video monitor in electronic communication with the first camera, the video monitor being adapted to depict a digital representation of the light the first camera receives from the light source. The first machine can also comprise a video monitor in electronic communication with the second camera, the video monitor being adapted to depict a digital representation of the light the second camera receives from the light source. Alternatively, the first machine can comprise a video monitor in simultaneous electronic communication with the first and second cameras, and being adapted to simultaneously depict a digital representation of the light the first and second cameras receive from the light source.

In another aspect of the invention, a second non-virtual reality fluoroscopic medical procedure simulation machine comprising a light source, a posterior reflective surface, a first camera, a second camera, an artificial lumen and an access port is disclosed. The light source can emit light in the visible wavelength range. Both cameras can be adapted to create a digital representation of the light they receive from the light source.

The artificial lumen can have an anterior side and a posterior side. The artificial lumen can have an anterior side opaque to the light source and a posterior side transparent to the light source. Alternatively, the artificial lumen can have an anterior side opaque to the light source and posterior side translucent to the light source. In another alternative, the artificial lumen can have an anterior side translucent to the light source and a posterior side transparent to the light source. In a last alternative, the artificial lumen can have an anterior side translucent to the light source and a posterior side translucent to the light source.

The artificial lumen can be oriented such that the anterior side of the artificial lumen is faced towards the light source. The artificial lumen can be positioned relative to the light source, first camera, second camera, and posterior reflective surface such that light emanating from the light source reflects from the anterior side of the artificial lumen to the first camera, and light emitted by the light source also reflects off the posterior reflective surface, transmits through the posterior side of the artificial lumen, reflects off the anterior side of the artificial lumen, and transmits back through the posterior side of the artificial lumen to the second camera.

The second machine can also comprise an access port. The access port can be positioned anterior to the artificial lumen and can be adapted to allow access to the artificial lumen with a medical instrument used during a fluoroscopic medical procedure.

In another aspect of the invention, the second machine can comprise a video monitor in electronic communication with the first camera, the video monitor being adapted to depict a digital representation of the light the first camera receives from the light source. The second machine can also comprise a video monitor in electronic communication with the second camera, the video monitor being adapted to depict a digital representation of the light the second camera receive from the light source. Alternatively, the first machine can comprise a video monitor in simultaneous electronic communication with the first and second cameras, and being adapted to simultaneously depict a digital representation of the light the first and second cameras receive from the light source.

### BRIEF DESCRIPTION OF THE DRAWINGS

FIG. 1 is a side view of one embodiment of the apparatus.

FIG. 2 is an end-on and side view of an artificial lumen having an opaque anterior side and a transparent posterior side.

FIG. 3 is an end-on and side view of an artificial lumen having a translucent anterior side and a transparent posterior side.

FIG. 4 is an end-on and side view of an artificial lumen having a translucent anterior side and a translucent posterior side.

FIG. 5 is an end-on and side view of an artificial lumen having an opaque anterior side and a translucent posterior side.

FIG. 6 demonstrates the effect of an algorithm or a minor interposed between an artificial lumen and video monitor can have on the left-to-right orientation of and image seen on a video monitor.

FIG. 7 is a side view of another embodiment of the apparatus.

FIG. 8 is a side view demonstrating a first machine embodiment of the invention wherein the light emitted by the light source passes through a properly oriented artificial lumen to a second camera.

FIG. 9 is a side view demonstrating an alternative of the first machine embodiment of the invention wherein the light emitted by the light source passes through a properly oriented artificial lumen, to a mirror, and to a second camera.

FIG. 10 is a side view demonstrating a second machine embodiment of the invention wherein light emitted by the light source passes through the posterior side of an artificial lumen, is reflected off the anterior side of an artificial lumen, passes back through the posterior side of the lumen, to a second camera.

FIG. 11 is a side view demonstrating an alternative of the second machine embodiment of the invention wherein light emitted by the light source reflects off a minor, passes through the posterior side of an artificial lumen, is reflected off the anterior side of an artificial lumen, passes back through the posterior side of the lumen, reflects off the minor, and to a second camera.

### DETAILED DESCRIPTION

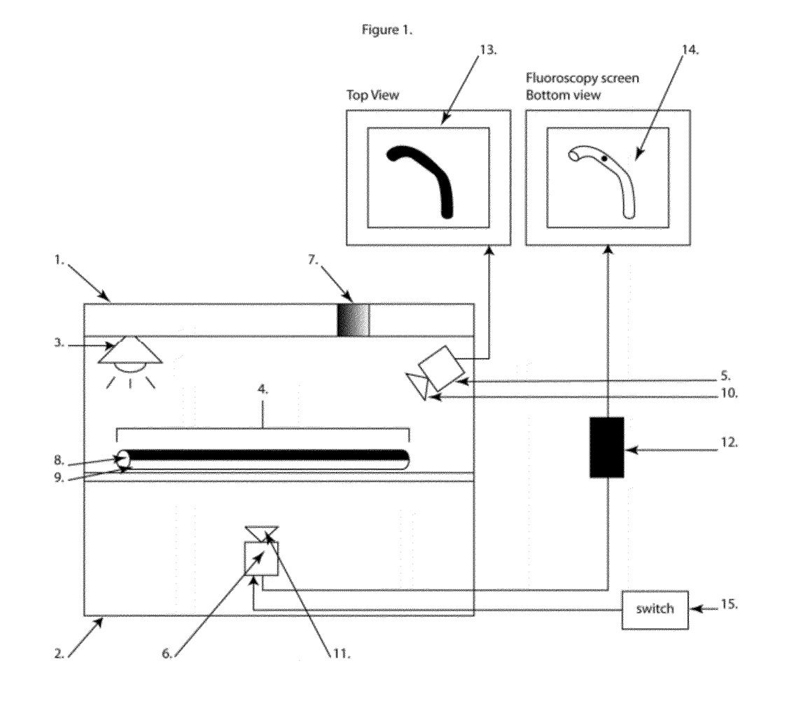

Referring the FIG. 1, a preferred embodiment of the apparatus disclosed herein may comprise an anterior end 1, a posterior end 2, and a light source 3. A preferred embodiment can also include an artificial lumen 4, a first camera 5, a second camera 6, and an access port 7. The light source 3 can be placed posterior to the anterior end 4 of the apparatus. The light source 3 can be oriented such that light emitted by it is faced towards the artificial lumen 4. While not necessary, in a preferred embodiment, the light source 3 emits light in the visible wavelength range. The light source 3 may be, but is not limited to, a light emitting diode, an incandescent bulb, or a fluorescent bulb. In an alternative embodiment of the apparatus disclosed herein, the apparatus can comprise a second light source (NOT SHOWN). The second light source can be disposed posterior to the artificial lumen 4, and may be faced towards the artificial lumen. While not necessary, the second light source can emit light in the visible wavelength range. The second light source may be, but is not limited to, a light emitting diode, an incandescent bulb, or a fluorescent bulb.

Referring to FIG. 1, in a further aspect of a preferred embodiment, the artificial lumen 4 may be disposed posterior to the light source 3. Further, the artificial lumen 3 can also be comprised of an anterior side 8, a posterior side 9, and may be oriented such that the anterior side 8 is faced towards the anterior end 1 of the apparatus, and the posterior side is faced towards the posterior end 2 of the apparatus.

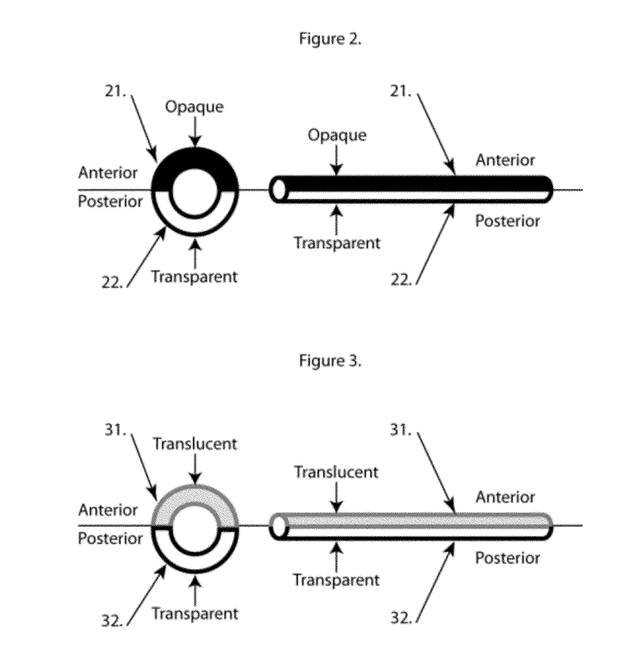

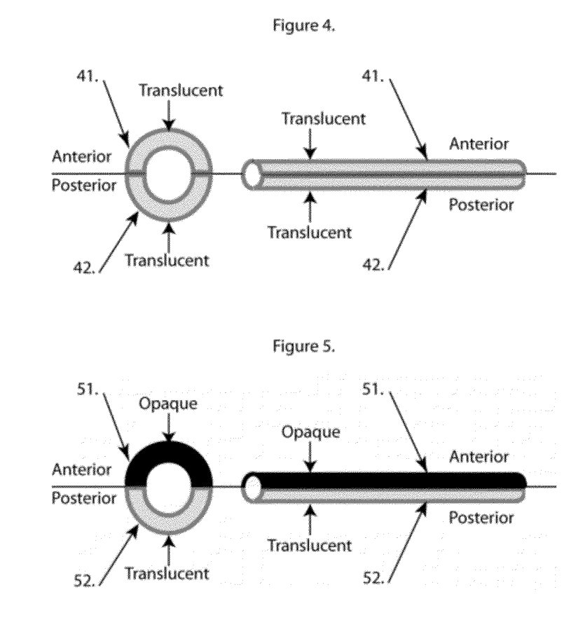

Referring to FIG. 2, in an exemplary embodiment the anterior side 21 of the artificial lumen may be comprised of a material that is opaque to the light emitted by the light source, and the posterior side 22 can be comprised of a material that is transparent the light emitted by the light source. Referring to FIG. 3, the anterior side 31 of the artificial lumen may be comprised of a material that is translucent to the light emitted by the light source and the posterior side 32 can be comprised of a material that is transparent the light emitted by the light source. Referring to FIG. 4, the anterior side 41 of the artificial lumen may be comprised of a material that is translucent to the light emitted by the light source, and the posterior side 42 can be comprised of a material that is translucent to the light emitted by the light source. The translucency of the anterior side 41 and posterior side 42 of the artificial lumen disclosed in this particular instance may be the same or different. Referring to FIG. 5, the anterior side 51 of the artificial lumen may be comprised of a material that is opaque to the light emitted by the light source, and the posterior side 52 can be comprised of a material that is translucent to the light emitted by the light source. The artificial lumen can be made from classes of materials including, but not limited to, polyolefins, polyamides, polyesters, vinyl polymers, polycarbonates, silicones, rubbers, and copolymers of the above. More specific examples of materials that may be considered include, but are not limited to, latex, polyvinyl chloride, polyurethane, polyethylene, perfluoroalkoxy, polypropylene, polyethylene terepthalate, and polytetrafluoroethylene. In a preferred embodiment, the material comprising the anterior side of the artificial lumen may be latex and the posterior side may be polyvinyl chloride. It is further understood that the degree of translucency of a material can be further modified by the incorporation of additives such as a pigment or dye, or may be modified by the addition of paint to a surface of a material. Moreover, it is to be understood that the translucency of a material may also be dependent on its thickness, and that varying the thicknesses of the materials to affect translucency is incorporated herein. Further, it is to be understood that the invention is not limited so long as posterior side of the artificial lumen of is capable of transmitting more light than the anterior side of the artificial lumen.

Referring to FIG. 1, the first camera 5 may be positioned anterior to the artificial lumen 8 and may further comprise a lens 10. The first camera may be oriented such that the lens is facing towards the anterior side 8 of the artificial lumen 4. Further, the first camera is adapted create a digital representation of the light it receives from the light source 3.

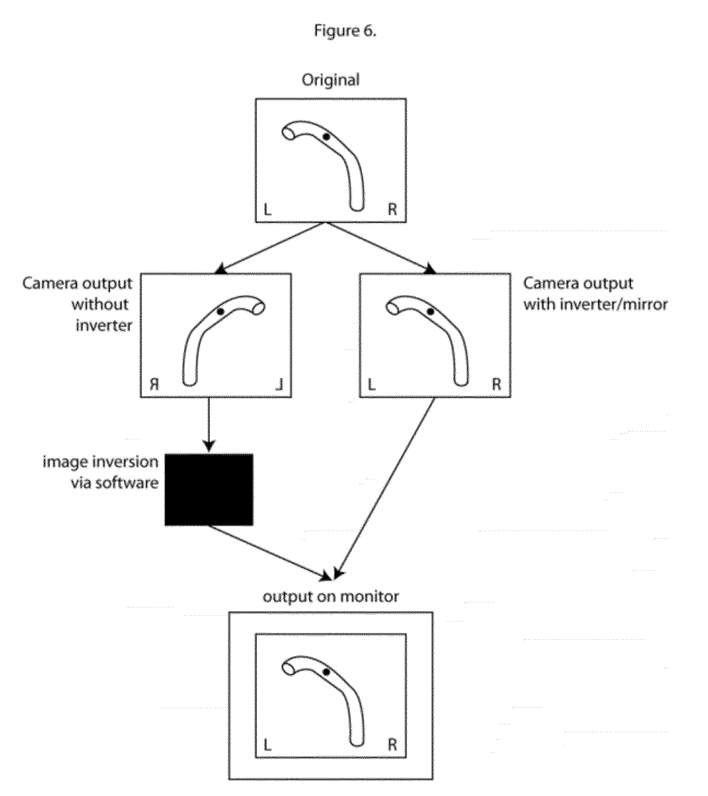

Referring to FIG. 1, a preferred embodiment of the apparatus may also comprise a second camera 6 having a lens 11. In a preferred embodiment, the second camera 6 may be placed posterior to the artificial lumen 4, oriented such that the lens 11 is faced towards the posterior side 9 of the artificial lumen, and adapted to create a digital representation of the light it receives from the light source 3. Further, the apparatus may comprise a power-switch 15 in electronic communication with the second camera 6 such that the switch controls power to the second camera, thus enabling a fluoroscopic and non-fluoroscopic mode with the simulator. Referring to FIGS. 1 and 6, the second camera 6 may also comprise a built-in algorithm to invert the left-to-right orientation of the digital representation of the light it receives from the light source 3. In an alternative embodiment, the apparatus may comprise a processor 12 post-second camera 6 that contains an algorithm to invert the left-to-right orientation of digital representation transmitted by the second camera.

Referring to FIG. 1, a preferred embodiment may also comprise an access port 7. The access port 7 may be positioned anterior to the artificial lumen 4, and adapted to allow passage of a trocar to a position anterior to the artificial lumen 4. In a preferred embodiment, the access port 7 may have a diameter between 1 mm and 50 mm. In another preferred embodiment, the access port 7 may have a diameter between 2 mm and 25 mm. In a further preferred embodiment, the access port 7 may have a diameter between the 3 mm and 20 mm. In a further preferred embodiment, the access port may have a diameter between 4 mm and 15 mm. In another preferred embodiment, the access port 7 may have a diameter between 5 mm and 10 mm. The trocar allows access to the artificial lumen with a medical instrument used during a fluoroscopic medical procedure. Medical instruments that can be passed through a trocar to interact with the artificial lumen can include, but are not limited to, graspers, scissors, clip appliers, needle drivers, endoscopes, laparoscopes, choledochoscopes, guide wires, dilating balloons, Fogarty catheters, and snares.

Referring to FIG. 1, a preferred embodiment of the apparatus may also include a first video monitor 13 in electronic communication with the first camera 5. The preferred embodiment may also include a second video monitor 14 in electronic communication with the second camera 6. Alternatively, the apparatus may comprise a single video monitor (NOT SHOWN) in simultaneous electronic communication with the first camera 5 and second camera 6.

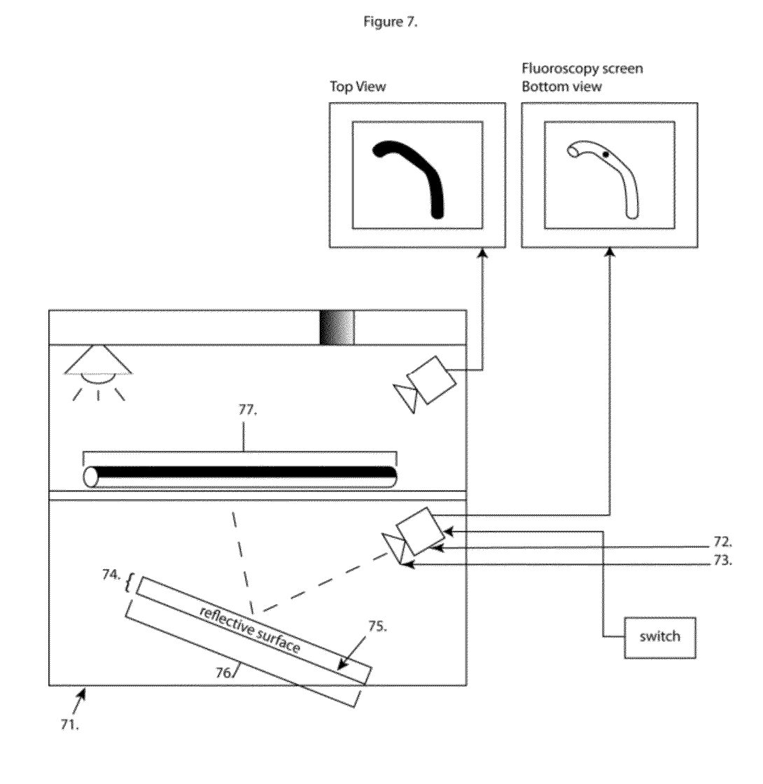

Referring to FIG. 7, in an alternative embodiment, the second camera 72 is oriented such that its lens 73 is faced towards the posterior end 71 of the apparatus. In this alternative embodiment, the apparatus may further comprise a mirror 74. The mirror 74 can comprise a reflective surface 75 and a non-reflective surface 76. The minor 74 may be positioned posterior to the artificial lumen 77 and the second camera 72, and is oriented such that its reflective surface 75 is faced towards both the artificial lumen and the second camera.

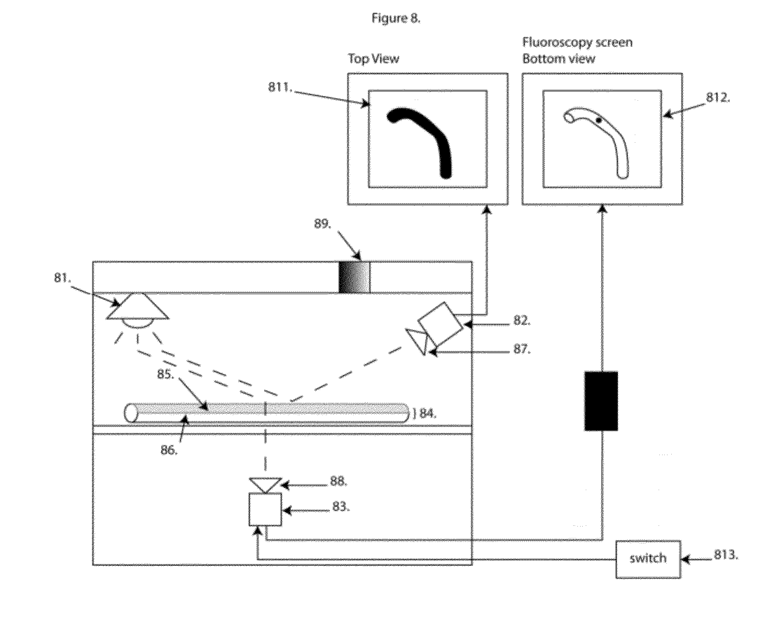

Referring to FIG. 8, a preferred embodiment of a first machine disclosed herein may comprise a light source 81, a first camera 82, and a second camera 83. While not necessary, in a preferred embodiment, the light source 81 can emit light in the visible wavelength range. In a preferred embodiment, the first camera 82 can have a lens 87, and may be adapted to create a digital representation of the light it receives from the light source 81. The preferred embodiment the second camera 83 may also have a lens 88 and may be adapted to create a digital representation of the light is receives from the light source 81. Further, the machine may comprise a power-switch 813 in electronic communication with the second camera 83 such that the switch controls power to the second camera, thus enabling a fluoroscopic and non-fluoroscopic mode with the simulator. In an alternative embodiment of the first machine disclosed herein, the machine may comprise a second light source (NOT SHOWN). While not necessary, the second light source can emit light in the visible wavelength range. The second light source may be, but is not limited to, a light emitting diode, an incandescent bulb, or a fluorescent bulb.

Referring to FIG. 8, in a preferred embodiment of a first machine disclosed herein, the machine may also comprise an artificial lumen 84. The artificial lumen 84 may have an anterior side 85 and a posterior side 86. The anterior side 85 may be comprised of a material translucent to the light emitted by the light source 81 and the posterior side 86 may be comprised of a material transparent to the light emitted by the light source. In an alternative embodiment, the anterior side 85 may be comprised of a material translucent to the light emitted by the light source 81 and the posterior side 86 may be comprised of a material translucent to the light emitted by the light source. The artificial lumen 84 may be oriented such that the anterior side 85 is faced towards the light source 81. The artificial lumen 84 may be positioned relative to the light source 81, first camera 82, and second camera 83 such that light emitted by the light source reflects from the anterior side 85 of the artificial lumen to the first camera, and such that light emitted by the light source transmits through the anterior side and posterior side 86 of the artificial lumen to the second camera.

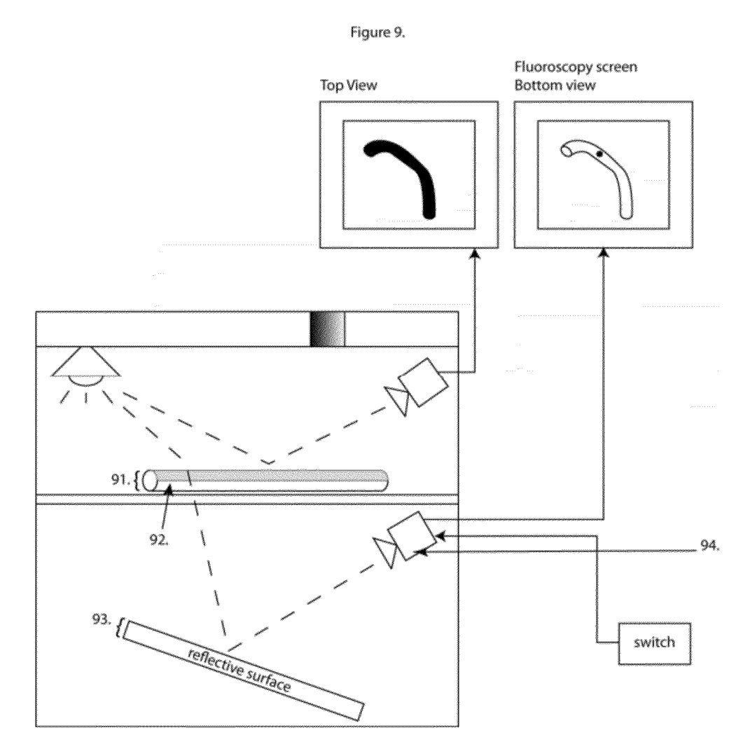

Referring to FIG. 8, in one mode of operation of the first machine disclosed herein, light is emitted by the light source 81, and light reflects off the anterior side 85 of the artificial lumen 84 to the first camera 82, thus enabling a simulated real-time extra-luminal view of a lumen (e.g. intestinal tract, vessels, and ducts) accessed during an actual fluoroscopic medical procedure. In this same mode of operation, some of the light emitted by the light source 81 is transmitted through anterior side 85 of the artificial lumen 84, and is further transmitted through the posterior side 86 of the artificial lumen to the second camera 83, thus enabling a simulated real-time intra-luminal view of a lumen (e.g. intestinal tract, vessels, and ducts) accessed during an actual fluoroscopic medical procedure. Referring to FIG. 9, in an alternative mode of operation, the light transmitted through the posterior side 92 of the artificial lumen 91 passes to a mirror 93, then to the second camera 94.

Referring to FIG. 8, a preferred embodiment of the first machine disclosed herein may also comprise an access port 89. The access port 89 may be positioned anterior to the artificial lumen 84, and adapted to allow passage of a trocar to a position anterior to the artificial lumen. In a preferred embodiment, the access port 89 may have a diameter between 1 mm and 50 mm. In another preferred embodiment, the access port 89 may have a diameter between 2 mm and 25 mm. In a further preferred embodiment, the access port 89 may have a diameter between the 3 mm and 20 mm. In a further preferred embodiment, the access port may have a diameter between 4 mm and 15 mm. In another preferred embodiment, the access port 89 may have a diameter between 5 mm and 10 mm. The trocar allows access to the artificial lumen with a medical instrument used during a fluoroscopic medical procedure. Medical instruments that can be passed through a trocar to interact with the artificial lumen can include, but are not limited to, graspers, scissors, clip appliers, needle drivers, endoscopes, laparoscopes, choledochoscopes, guide wires, dilating balloons, Fogarty catheters, and snares.

In another embodiment of the first machine disclosed herein, the machine may also include a first video monitor 811 in electronic communication with the first camera 82, the first video monitor adapted to depict a digital representation of the light received by the first camera. The first video monitor 811 in electronic communication with the first camera 82 enables a real-time extra-luminal view of a thus enabling a simulated real-time extra-luminal view of a the artificial lumen by the machine operator. The preferred embodiment may also include a second video monitor 812 in electronic communication with the second camera 83, the second video monitor adapted to depict a digital representation of the light received by the second camera. The second video monitor 813 in electronic communication with the second camera 83 enables a real-time intra-luminal view of the artificial lumen by the machine operator. Alternatively, the apparatus may comprise a single video monitor (NOT SHOWN) in simultaneous electronic communication with the first camera 82 and second camera 83, this single video monitor adapted to depict a digital representation of the light received by the first camera and second camera. This set-up enables a real-time extra-luminal and intra-luminal view by the operator on one video monitor.

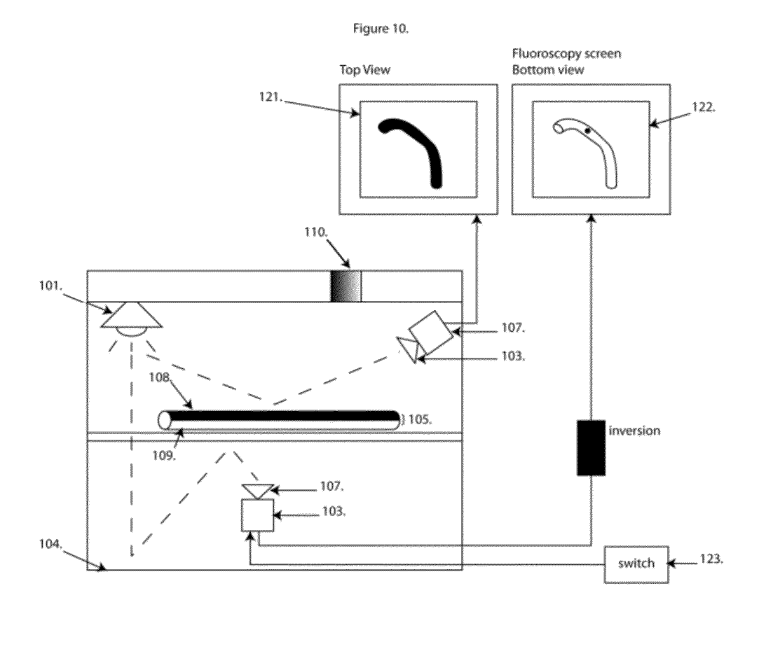

Referring to FIG. 10, a preferred embodiment of a second machine disclosed herein may comprise a light source 101, a first camera 102, a second camera 103, and a posterior surface 104. While not necessary, in a preferred embodiment, the light source 101 can emit light in the visible wavelength range. In a preferred embodiment, the first camera 102 can have a lens 106, and may be adapted to create a digital representation of the light it receives from the light source 101. In a preferred embodiment the second camera 103 may have a lens 107 and may be adapted to create a digital representation of the light is receives from the light source 101. In a preferred embodiment of the machine disclosed herein, the posterior reflective surface 104 is a white or may be a mirror. Further, the machine may comprise a power-switch 123 in electronic communication with the second camera 103 such that the switch controls power to the second camera, thus enabling a fluoroscopic and non-fluoroscopic mode with the simulator. In an alternative embodiment of the second machine disclosed herein, the machine may comprise a second light source (NOT SHOWN). While not necessary, the second light source can emit light in the visible wavelength range. The second light source may be, but is not limited to, a light emitting diode, an incandescent bulb, or a fluorescent bulb.

Referring to FIG. 10, in a preferred embodiment of a second machine disclosed herein, the machine may also comprise an artificial lumen 105. The artificial lumen 105 may have an anterior side 108 and a posterior side 109. The anterior side 109 may be comprised of a material opaque to the light emitted by the light source 101 and the posterior side 109 may be comprised of a material transparent to the light emitted by the light source. In a first alternative embodiment, the anterior side 108 of the artificial lumen 105 may be comprised of a material opaque to the light emitted by the light source 101 and the posterior side 109 may be comprised of a material translucent to the light emitted by the light source. In a second alternative embodiment, the anterior side 108 of the artificial lumen 105 may be comprised of a material translucent to the light emitted by the light source 101 and the posterior side 109 may be comprised of a material transparent to the light emitted by the light source. In a third alternative embodiment, the anterior side 108 of the artificial lumen 105 may be comprised of a material translucent to the light emitted by the light source 101 and the posterior side 109 may be comprised of a material translucent to the light emitted by the light source. The artificial lumen 105 may be oriented such that the anterior side 108 is faced towards the light source 101. The artificial lumen 105 may be positioned relative to the light source 101, first camera 102, posterior reflective surface 104, and second camera 103 such that light emitted by the light source reflects from the anterior surface of the artificial lumen 108 to the first camera, and such that light emitted by the light source also reflects off the posterior reflective surface, is transmitted through the posterior side 109 of the artificial lumen, reflects off the anterior side of the artificial lumen, is transmitted back through the posterior side of the artificial lumen, to the second camera.

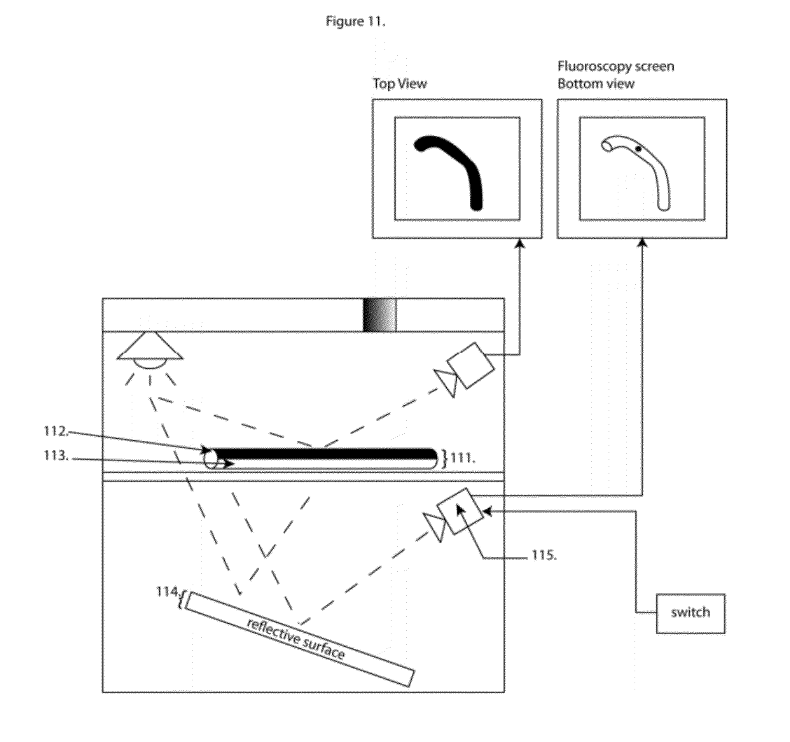

Referring to FIG. 10, in one mode of operation of the second machine disclosed herein, light is emitted by the light source 101, the light emitted by the light source reflects off the anterior side 108 of the artificial lumen 105 to the first camera, thus enabling a simulated real-time extra-luminal view of a lumen (e.g. intestinal tract, vessels, and ducts) accessed during an actual fluoroscopic medical procedure. In this same mode of operation, some of the light emitted by the light source 101 is reflected off the posterior reflective surface 104, transmitted through the posterior side 109 of the artificial lumen 105, reflected off the anterior side 108 of the artificial lumen, transmitted back through the posterior side of the artificial lumen to the second camera 103, thus enabling a simulated real-time intra-luminal view of a lumen (e.g. intestinal tract, vessels, and ducts) accessed during an actual fluoroscopic medical procedure. Referring to FIG. 11, in an alternative mode of operation, the light transmitted back through the posterior side 112 of the artificial lumen 111 passes to a mirror 114, and then to the second camera 115.

Referring to FIG. 10, a preferred embodiment of the second machine disclosed herein may also comprise an access port 110. The access port 110 may be positioned anterior to the artificial lumen 105, and adapted to allow passage of a trocar to a position anterior to the artificial lumen. In a preferred embodiment, the access port 110 may have a diameter between 1 mm and 50 mm. In another preferred embodiment, the access port 110 may have a diameter between 2 mm and 25 mm. In a further preferred embodiment, the access port 110 may have a diameter between the 3 mm and 20 mm. In a further preferred embodiment, the access port may have a diameter between 4 mm and 15 mm. In another preferred embodiment, the access port 110 may have a diameter between 5 mm and 10 mm. The trocar allows access to the artificial lumen with a medical instrument used during a fluoroscopic medical procedure. Medical instruments that can be passed through a trocar to interact with the artificial lumen can include, but are not limited to, graspers, scissors, clip appliers, needle drivers, endoscopes, laparoscopes, choledochoscopes, guide wires, dilating balloons, Fogarty catheters, and snares.

In another embodiment of the second machine disclosed herein, the machine may also include a first video monitor 121 in electronic communication with the first camera 102, the first video monitor adapted to depict a digital representation of the light received by the first camera. The first video monitor 121 in electronic communication with the first camera 102 enables a real-time extra-luminal view by the machine operator. The preferred embodiment may also include a second video monitor 122 in electronic communication with the second camera 103, the second video monitor adapted to depict a digital representation of the light received by the second camera. The second video monitor 122 in electronic communication with the second camera 103 enables a real-time intra-luminal view by the machine operator. Alternatively, the apparatus may comprise a single video monitor (NOT SHOWN) in simultaneous electronic communication with the first camera 102 and second camera 103, this single video monitor adapted to depict a digital representation of the light received by the first camera and second camera. This set-up enables a real-time extra-luminal and intra-luminal view by the operator on one video monitor.

An implementation of the apparatus and machines disclosed herein is employable with one or more simulated interventions such as medical interventions. Examples of simulated medical interventions employable with an implementation of the apparatus and machines comprise interventions using fluoroscopic guidance in the upper or lower extremities, abdomen, pelvis, thorax, neck, and cranium such as interventional radiology procedures (breast lesion localization, hysterosalpingography, abscess/fluid collection drainage/sampling procedures including abdominal/thoracic/cranial drain placement, injections, aspiration, biopsies; lymphangiography, sialography, vertebroplasty, percutaneous tracheostomy placement, venous and arterial access sampling/catheter placement, transjugular liver access/biopsy, renal biopsy, venous access device placement/removal, feeding tube placement/repositioning/removal), urologic procedures (wire/catheter/stent placement into the bladder, ureters, or upper urinary tract, stone extraction, endoscope guidance/localization), gastrointestinal procedures (foreign body removal, biliary/pancreatic drain/stent placement, biopsy, stone extraction, common bile duct exploration, endoscopic retrograde pancreatocholangiography, esophageal/gastric/colonic stricture dilation, biopsy, catheter/drain placement, feeding tube placement, endoscope guidance/localization), pulmonary procedures (stricture dilation, foreign body removal, biopsy, endoscope guidance/localization), cardiovascular procedures (angiography, angioplasty, stent placement, catheter placement, aortic graft placement, percutaneous cardiac access procedures, cardiac lead and pacemaker placement, vena cava filter placement), natural orifice translumenal endoscopic surgery (NOTES®) procedures, percutaneous placement of therapeutic or drug-delivery devices, fiduciary markers, and in general any other fluoroscopically-assisted or -guided diagnostic or therapeutic procedures. An implementation of the apparatus is employable with fluoroscopy such as for medical simulation of percutaneous procedures, for example, central line placement, cardiac catheterization, endovascular interventions, and a number of catheter-based percutaneous procedures.

It should be understood that the methods, procedures, operations, devices, and systems illustrated in FIGS. 1-11 may be modified without departing from the spirit of the invention. For example, these methods, procedures, operations, devices, and systems may comprise more or fewer steps or components than appear herein, and these steps or components may be combined with one another, in part or in whole.

Furthermore, the present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions.

It is to be understood that this disclosure is not limited to particular methods, reagents, compounds compositions or biological systems, which can, of course, vary. It is also to be understood that the terminology used herein is for the purpose of describing particular embodiments only, and is not intended to be limiting. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are intended as “open” terms (e.g., the term “including” should be interpreted as “including but not limited to,” the term “having” should be interpreted as “having at least,” the term “includes” should be interpreted as “includes but is not limited to,” etc.).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, Band C together, and/or A, B, and C together, etc.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

As will also be understood by one skilled in the art, all language such as “up to,” “at least,” “greater than,” “less than,” and the like include the number recited and refer to ranges which can be subsequently broken down into subranges as discussed above.

Finally, as will be understood by one skilled in the art, a range includes each individual member. Thus, for example, a group having 1-3 members refers to groups having 1, 2, or 3 members. Similarly, a group having 1-5 members refers to groups having 1, 2, 3, 4, or 5 members, and so forth.

What is claimed is:

1. A non-virtual reality fluoroscopic medical procedure simulation apparatus comprising:
an anterior end;
a posterior end;
a light source,
the light source disposed posterior to the anterior end and oriented such that the light emanating from the light source is faced towards the posterior end, and wherein the light source emits light in the visible wavelength range;
an artificial lumen,
the artificial lumen disposed posterior to the light source, the artificial lumen having an anterior side and a posterior side and oriented such that the anterior side is faced towards the anterior end of the apparatus and the posterior side is faced towards the posterior end of the apparatus;
a first camera,
the first camera disposed anterior to the artificial lumen, the camera having a lens and oriented such that the lens is faced towards the anterior side of the artificial lumen, and wherein the first camera is adapted to create a digital representation of the light it receives from the light source;
a second camera,
the second camera placed posterior to the artificial lumen, the camera having a lens, and wherein the second camera is adapted to create a digital representation of the light it receives from the light source;
an access port,
the access port positioned anterior to the artificial lumen and having a diameter;
a first video monitor,
the first video monitor in electronic communication with the first camera; and
a second video monitor,
the second video monitor in electronic communication with the first camera.

2. The apparatus of claim 1 wherein the anterior side of the artificial lumen is opaque to the light emitted by the light source and the posterior side is transparent to the light emitted by the light source.

3. The apparatus of claim 1 wherein the anterior side of the artificial lumen is opaque to the light emitted by the light source and the posterior side is translucent to the light emitted by the light source.

4. The apparatus of claim 1 wherein the anterior side of the artificial lumen is translucent to the light emitted by the light source and the posterior side is transparent to the light emitted by the light source.

5. The apparatus of claim 1 wherein the anterior side of the artificial lumen is translucent to the light emitted by the light source and the posterior side of the artificial lumen is translucent to the light emitted by the light source.

6. The apparatus of claim 1 wherein the second camera is oriented with its lens faced towards the posterior side of the artificial lumen, and wherein a built-in algorithm inverts the left-to-right orientation of the digital representation the second camera creates from the light the second camera receives from the light source.

7. The apparatus of claim 1 wherein the second camera is oriented with its lens faced towards the posterior side of the artificial lumen, the apparatus further comprising a processor post-second camera, the processor in electronic communication with the second camera, the processor comprising an algorithm that inverts the left-to-right image orientation of the digital representation the second camera creates from the light the second camera receives from the light source.

8. The apparatus of claim 1 wherein the second camera is oriented such that the lens is faced towards the posterior end of the apparatus, the apparatus further comprising a minor, the mirror positioned posterior to both the artificial lumen and second digital camera, the mirror having a reflective surface and a non-reflective surface and oriented such that the reflective surface is faced towards both the posterior side of the artificial lumen and the second camera.

9. The apparatus of claim 1 wherein the diameter of the access port is between 1 mm and 50 mm.

10. A machine for non-virtual reality simulation of a fluoroscopic medical procedure comprising:
a light source,
the light source emitting light in the visible wavelength range;
a first camera,
the first camera having a lens, and adapted to create a digital representation of the light it receives from the light source;
a second camera,
the second camera having a lens, and adapted to create a digital representation of the light it receives from the light source;
an artificial lumen,
the artificial lumen having an anterior side and a posterior side, the artificial lumen being oriented such that the anterior side is faced towards the light source, and wherein the artificial lumen is positioned relative to the light source, first camera, and second camera such that light emitted by the light source reflects from the anterior side of the artificial lumen to the first camera and light emitted by the light source also transmits through anterior side of the artificial lumen through the posterior side of the artificial lumen to the second camera;
an access port,
the access port positioned anterior to the artificial lumen and having a diameter;
a first video monitor,
the first video monitor in electronic communication with the first camera and adapted to depict a digital representation of the light the first camera receives from the light source; and
a second video monitor,
the second video monitor in electronic communication with the second camera and adapted to depict a digital representation of the light the second camera receives from the light source.

11. The machine of claim 10 wherein the anterior side of the artificial lumen is translucent to the light emitted by the light source and the posterior side of the artificial lumen is transparent to the light emitted by the light source.

12. The machine of claim 10 wherein the anterior side of artificial lumen is translucent to the light emitted by the light source and the posterior side of the artificial lumen is translucent to the light emitted by the light source.

13. The machine of claim 10 wherein the diameter of the access port is between 1 mm and 50 mm.

14. The machine of claim 10 further comprising a second light source disposed posterior to the artificial lumen, the second light source oriented such that the light emanating from it is faced towards the posterior side of the artificial lumen, and wherein the second light source emits light in the visible wavelength range.

15. A machine for non-virtual reality simulation of a fluoroscopic medical procedure comprising:
a light source,
the light source emitting light in the visible wavelength range;
a first camera,
the first camera having a lens, and adapted to create a digital representation of the light it receives from the light source;
a second camera,
the second camera having a lens, and adapted to create a digital representation of the light it receives from the light source;
a posterior reflective surface;
an artificial lumen,
the artificial lumen having an anterior side and a posterior side, the artificial lumen oriented such that the anterior side is faced towards the light source, the artificial lumen being positioned relative to the light source, first camera, and second camera such that light emitted by the light source reflects off the anterior side of the artificial lumen to the first camera and wherein light from the light source reflects off the posterior reflective surface, transmits through the posterior side of the artificial lumen, reflects off the anterior side of the artificial lumen, transmits back through the posterior side of the artificial lumen to the second camera;
an access port,
the access port positioned anterior to the artificial lumen and having a diameter;
a first video monitor,
the first video monitor in electronic communication with the first camera and adapted to depict a digital representation of the light the first camera receives from the light source; and
a second video monitor,
the second video monitor in electronic communication with the second camera and adapted to depict a digital representation of the light the second camera receives from the light source.

16. The machine of claim 15 wherein the anterior side of the artificial lumen is opaque to the light emitted by the light source and the posterior side of the artificial lumen is transparent to the light emitted by the light source.

17. The machine of claim 15 wherein the anterior side of the artificial lumen is opaque to the light emitted by the light source and the posterior side of the artificial lumen is translucent to the light emitted by the light source.

18. The machine of claim 15 wherein the anterior side of the artificial lumen is translucent to the light emitted by the light source and the posterior side of the artificial lumen is transparent to the light emitted by the light source.

19. The machine of claim 15 wherein the anterior side of the artificial lumen is translucent to the light emitted by the light source and the posterior side of the artificial lumen is translucent to the light emitted by the light source.

20. The machine of claim 15 wherein the diameter of the access port is between 1 mm and 50 mm.
